(19) United States
(12) Patent Application Publication
(10) Pub. No.: US 2015/0375966 A1
(43) Pub. Date: Dec. 31, 2015

(54) Noise Abatement for Elevator Submersible Power Units

(71) Applicant: ThyssenKrupp Elevator Corporation, Atlanta, GA (US)

(72) Inventors: Anthony Frank Hamlett, Franklin, TN (US); Aaron Bailey, Germantown, TN (US); Chris B. Jackson, Blue Mountain, MS (US); Roy J. Walker, Bartlett, TN (US)

(21) Appl. No.: 14/320,596

(22) Filed: Jun. 30, 2014

(51) Int. Cl. B66B 11/04; F16L 55/033; F16L 55/04; F15B 21/00

(52) U.S. Cl. CPC B66B 11/0423; F15B 21/008; F16L 55/033; F16L 55/04

(57) ABSTRACT

A hydraulic elevator system includes a tank and power unit configured with noise and/or vibration abatement features. In one aspect the tank may include an insulated and sealed lid. In another aspect tank-to-floor dampening pads may be used. In another aspect the tank may have an increased thickness and/or stiffening trays or panels may be installed on the tank. Still in yet other aspects the noise and/or vibration abatement features may be associated with the power unit. For instance, in one aspect of the present disclosure the power unit may mount to the tank using a plurality of isolators. In another aspect, silencers and/or an expansion tank may be used to alter the hydraulic fluid flow properties within the system. Still yet, in another aspect certain noise generating components of the power unit may be wrapped in a noise blanket having an air barrier within.

### BACKGROUND

Hydraulic elevator systems may include, among other things, a motor, a pump, a valve, an oil tank or reservoir, and a hydraulic cylinder. These and other components are used with an elevator controller to control movement of an elevator car by directing hydraulic fluid or oil to and from the hydraulic cylinder, in such elevator systems, certain components may be positioned within the hoistway or in a space remote from the hoistway but in fluid and electrical communication with components within the hoistway. Regardless of the precise placement of such components, some of the noise, vibrations, heat generation, and/or odors associated with the hydraulic elevator system may be noticeable to passengers in the elevator car or to people at the floor landings or nearby. Thus it may be desirable to provide a hydraulic elevator system where the transmission of such noises, vibrations, heat, and/or odors is inhibited during operation to thereby provide for better ride quality and a better surrounding environment. While a variety of devices, systems, and methods for operating a hydraulic elevator while inhibiting the transmission of noise, vibrations, heat, and/or odors may have been made and used, it is believed that no one prior to the inventor(s) has made or used the devices, systems, and methods as described herein.

### SUMMARY

Disclosed herein is a hydraulic elevator system having a tank and power unit configured with noise and/or vibration abatement features. Accordingly, it is an object of the present disclosure to provide a hydraulic elevator system that produces less noise and/or vibration compared to other hydraulic elevator systems. In one aspect of the present disclosure the tank may include an insulated and sealed lid. In another aspect tank-to-floor dampening pads may be used. In another aspect the tank may have an increased thickness and/or stiffening trays or panels may be installed on the tank. Still in yet other aspects the noise and/or vibration abatement features may be associated with the power unit. For instance, in one aspect of the present disclosure the power unit may mount to the tank using a plurality of isolators. In another aspect, silencers and/or an expansion tank may be used to alter the hydraulic fluid flow properties within the system. Still yet, in another aspect certain noise generating components of the power unit may be wrapped in a noise blanket having an air barrier within.

Other aspects, features, and techniques within the scope of the present disclosure will become more apparent to those of ordinary skill in the art from the following description taken in conjunction with the drawings.

### BRIEF DESCRIPTION OF THE DRAWINGS

FIG. 1 is a schematic diagram of an embodiment of a hydraulic elevator system as disclosed herein.

FIG. 2 is a perspective view of a tank of the hydraulic elevator system of FIG. 1.

FIG. 3A is a partially exploded perspective view of the tank of FIG. 2.

FIG. 3B is an exploded side view of the lid of the tank of FIG. 2.

FIG. 4 is a top view of the tank of FIG. 2, shown without the tank lid.

FIG. 5 is a side view of the tank of FIG. 2, shown without the tank lid.

FIG. 6 is a front cross section view of the tank of FIG. 2, taken along line 6-6 as shown in FIG. 4.

FIG. 7 is a side cross section view of the tank of FIG. 2, taken along line 7-7 as shown in FIG. 4.

FIG. 8 is a perspective view of a stiffening tray of the tank of FIG. 2.

FIG. 9 is a perspective view of another stiffening tray of the tank of FIG. 2.

FIG. 10 is a perspective partial section view of the tank of FIG. 2 showing an embodiment of a power unit of a hydraulic elevator system as disclosed herein.

FIG. 11 is a front view of the power unit of FIG. 10, shown without the tank.

FIG. 12 is a top view of an isolator of the power unit of FIG. 10.

FIG. 13 is a side cross section view of the isolator of the power unit of FIG. 10, taken along line 13-13 as shown in FIG. 12.

FIG. 14 is a side cross section view of an embodiment of an expansion tank of the power unit of FIG. 10.

FIG. 15 is a front view of a silencer of the power unit of FIG. 10, shown with a portion cut-away to show internal components.

FIG. 16 is a front view of another silencer of the power unit of FIG. 10, shown with a portion cut-away to show internal components.

FIG. 17 is a partial rear view of the power unit of FIG. 10, showing an embodiment of a noise blanket wrapped around certain components of the power unit.

FIG. 18 is a side view of a portion of the noise blanket of FIG. 17 configured to cover the pump of the power unit.

FIG. 19 is a perspective view of the portion of the noise blanket of FIG. 18.

FIG. 20 is a side view of a portion of the noise blanket of FIG. 17 configured to cover the expansion tank of the power unit.

FIG. 21 is a perspective view of the portion of the noise blanket of FIG. 20.

FIG. 22 is a side view of a portion of the noise blanket of FIG. 17 configured to cover the motor bottom of the power unit.

FIG. 23 is a perspective view of the portion of the noise blanket of FIG. 22.

FIG. 24 is a side view of a portion of the noise blanket of FIG. 17 configured to cover the motor top of the power unit.

FIG. 25 is a perspective view of the portion of the noise blanket of FIG. 24.

The drawings are not intended to be limiting in any way, and it is contemplated that various embodiments of the present disclosure may be carried out in a variety of other ways, including those not necessarily depicted in the drawings. The accompanying drawings incorporated in and forming a part of the specification illustrate several aspects, and together with the description serve to explain the principles of the present disclosure; it being understood, however, that the scope of the present disclosure is not limited to the precise arrangements shown.

### DETAILED DESCRIPTION

The following description of certain embodiments should not be used to limit the scope of the present disclosure. Other examples, features, aspects, embodiments, and advantages will become apparent to those skilled in the art from the following description. As will be realized, various aspects of the present disclosure may take alternate forms, or have alternate or additional embodiments, without departing from the scope of the present disclosure. Accordingly, the drawings and descriptions should be regarded as illustrative in nature and not restrictive.

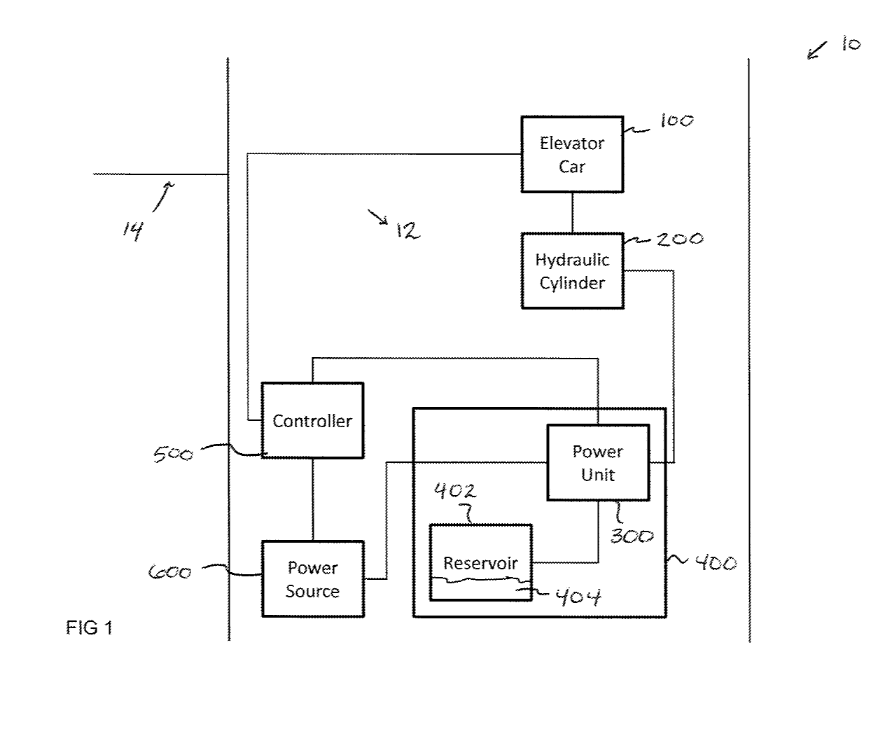

FIG. 1 shows a schematic diagram of an embodiment of a hydraulic elevator system (10). The hydraulic elevator system (10) is positioned within a hoistway (12). The hydraulic elevator system (10) includes an elevator car (100) connected to a hydraulic cylinder (200). The hydraulic cylinder (200) is in fluid communication with a power unit (300) that is positioned within a tank (400). The tank (400) includes a reservoir or space (402) within the tank (400) that is configured to hold hydraulic fluid or oil (404). The power unit (300) is in fluid communication with the reservoir (402) and is configured to direct the oil (404) to and from the cylinder (200) to raise and lower the elevator car (100).

The power unit (300) is further in electrical communication with an elevator controller (500). The controller (500) is in electrical communication with the elevator car (100) as well as call stations (not shown) at various landings (14) within the building. The controller (500) is configured to receive inputs from the elevator car (100) or call stations—e.g. a passenger's request to travel to a particular destination by selecting a destination on a user interface located within the elevator car (100) or outside the elevator car (100), for instance at one of the call stations. The controller (500) processes the received inputs and controls the power unit (300) to ultimately control movement of the elevator car (100).

The power unit (300) and controller (500) are also in electrical communication with a power source (600). The power source (600) can be a standard electrical source of power within a building, e.g. 110 volt or 220 volt electrical receptacles with the power provided by a utility provider, or the power source (600) may use electrical power generated locally or onsite via a generator, battery, or other power generation and/or storage means. The elevator car (100) is also provided with electrical power, e.g. by way of the controller (500) or another means separate from the controller (500). The power supplied to the elevator car (100) may be used to operate lighting, a car operating panel within the elevator car (100) for receiving passenger destination inputs and other commands, among other things that will be apparent to one of ordinary skill in the art.

Tank Configuration

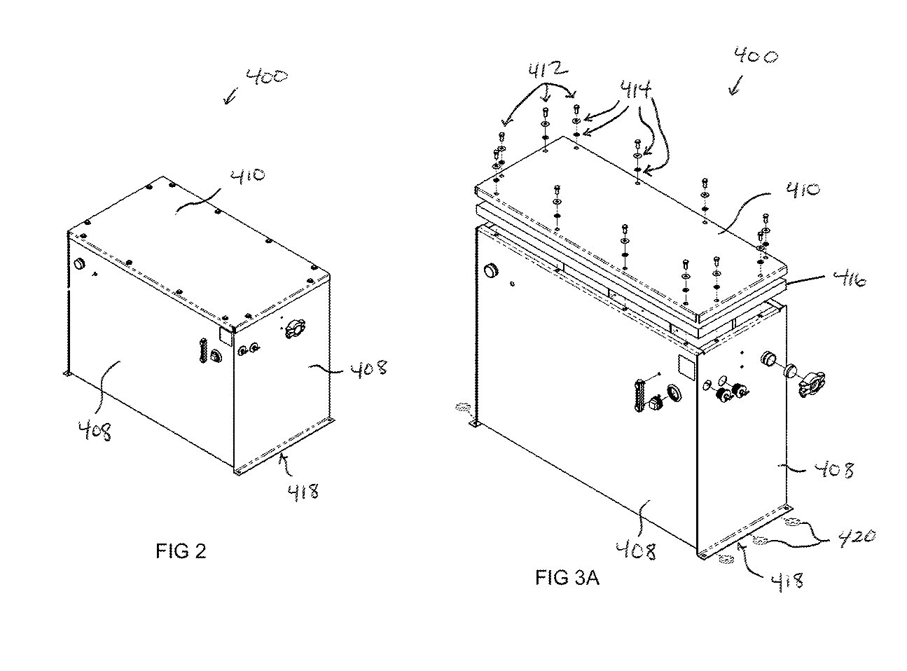

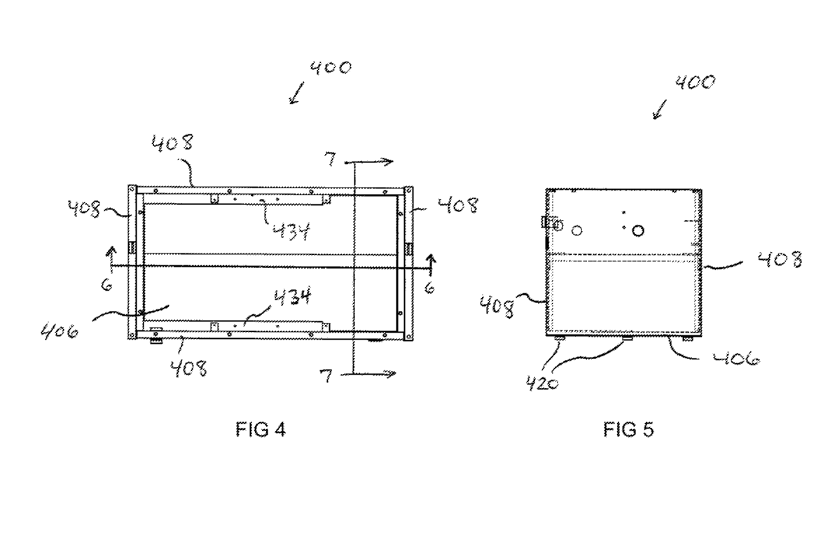

FIGS. 2-7 show views of an embodiment of the tank (400). The tank (400) comprises a bottom (406), walls (408), and a top or lid (410). The walls (408) are connected to the bottom (406) and to each other in a manner such that the tank (400) is fluidly sealed. In one embodiment each of the walls (408) is welded to the bottom (406) and then each wall (408) is welded to its adjacent walls (408) to create a sealed tank (400). Other ways to achieve a sealed construction for the tank (400) will be apparent to those of ordinary skill in the art in view of the teachings herein.

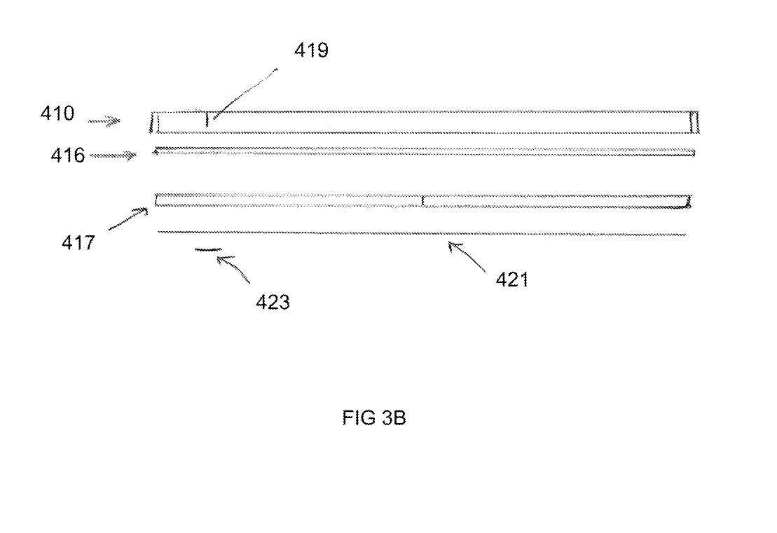

The lid (410) of the tank (400) is also configured to connect with the walls (408) such that the tank (400) is sealed. In the present embodiment, the lid (410) connects to the tank (400) using fasteners (412) such as bolts or screws along with one or more washers (414). The fasteners (412) extend through the washers (114), through bores within the lid (410), and then into bores within the walls (408). In one embodiment as shown in FIGS. 3A and 3B, the tank (400) comprises a foam sheet (416) that is positioned and clamped between the lid (410) and the walls (408) of the tank (400) to form a seal. In some embodiments, the foam sheet (416) may be a closed-cell foam material that may be oil-resistant and compatible with hydraulic fluid. Some such materials may include, but are not limited to, neoprene closed-cell foams, vinyl closed-cell foams, and nitrile (Buna-N) closed-cell foams. Other types of closed-cell foams will be apparent to those of ordinary skill in the art in view of the teachings herein. As shown in FIG. 3B, the lid (410) further comprises another foam sheet (417) that is positioned adjacent the foam sheet (416) for forming the seal. Foam sheet (417) may be an open-cell foam material configured to reduce airborne noise from passing through the lid (410). With this configuration, the lid (410) has a layered configuration that includes both the foam sheet (417) for noise reduction and the foam sheet (416) for sealing the tank (400). In some embodiments, the material for the foam sheet (417) may be polyester urethane, however other suitable materials may be used. In some embodiments, the foam sheets (416, 417) connect with the lid (410) by way of a retaining stud (419), a wire mesh (421), and a retaining clip (423). As best shown in FIG. 3B, the retaining stud (419) connects to the lid (410) and extends through the foam sheets (416, 417) and the wire mesh (421) before ultimately connecting to the retaining clip (423). In view of the teachings herein, other ways to assemble the lid (410) and the foam sheets (416, 417) will be apparent to one of ordinary skill in the art.

In one embodiment the lid (410) of the tank (400) has increased thickness to provide sound and vibration resistance. For example, the lid (410) can be comprised of 12 gage (0.097 inch) metal. In some other versions the lid (410) may be constructed of thicker or thinner material as will be apparent to those of ordinary skill in the art in view of the teachings herein. Similarly, in some embodiments the walls (408) and bottom (406) of the tank (400) may have an increased thickness. In some embodiments that will be discussed further below, that tank (400) may be stiffened and effectively thickened in areas using certain stiffening structures.

Referring to FIGS. 3 and 5, the tank (400) comprises bottom flanges or feet (418) on at least two sides of the tank (400). Each of the feet (418) includes bores configured to receive a bolt or other fastener to secure the tank (400) to the floor. In the present embodiment shown in FIGS. 3 and 5, a plurality of dampening pads (420) is positioned between the feet (418) and the floor to which the tank (400) is secured. The dampening pads (420) are configured to dampen vibrations between the tank (400) and the floor. In one embodiment, the dampening pads (420) are made of a material that provides good dampening qualities such as, but not limited to, nitrile, neoprene, rubber, and silicone. In some embodiments, dampening pads (420) may be comprised of felt or partly comprised of felt. As shown in the illustrated embodiment, the dampening pads (420) have a cylindrical shape with recessed areas within the circular top and bottom surfaces of the cylindrical shape. In one embodiment, the dampening pads (420) have a thickness of about one-half inch, of course other thicknesses may be used. Other shapes, sizes, and materials for the dampening pads (420) may be used in other embodiments, and such other shapes, sizes, and materials will be apparent to those of ordinary skill in the art in view of the teachings herein.

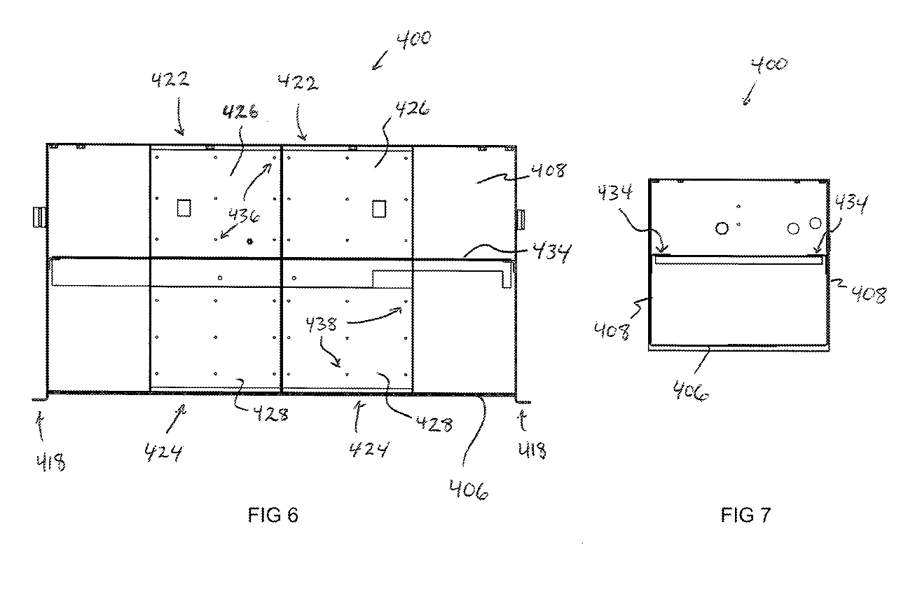

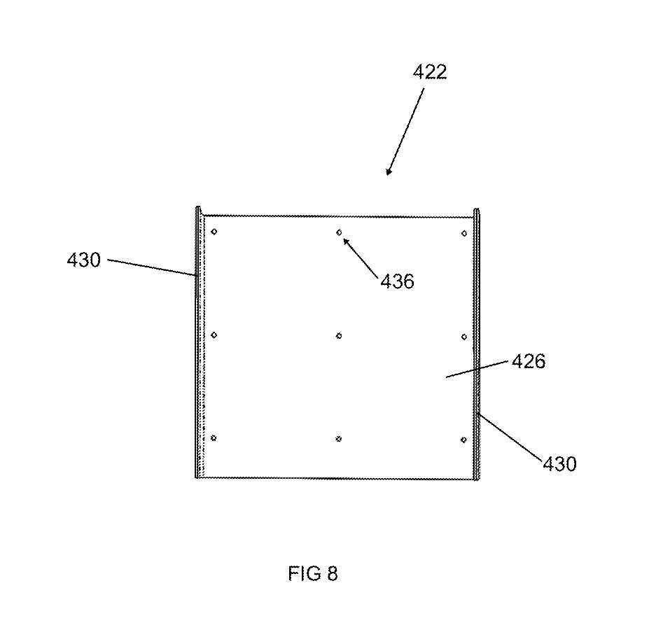

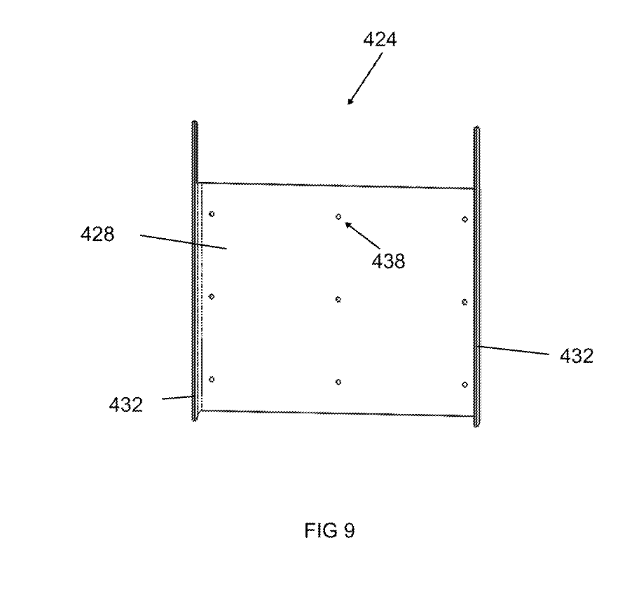

Referring to FIGS. 6-9, in some embodiments the tank (400) comprises multiple upper and lower stiffening trays (422, 424). These stiffening trays (422, 424) are configured to connect to the tank (400) and reduce airborne noise transmission as described further below. As shown in FIGS. 8 and 9, the upper and lower stiffening trays (422, 424) comprise respective sheet sections (426, 428) and respective side flanges (430, 432) that extend along the length of the respective sheet sections (426, 428). In the embodiment of the lower tray (424) shown in FIG. 9, the side flanges (432) extends beyond the length of the sheet section (428). The upper and lower trays (422, 424) are configured to connect to portions of the walls (408) along the interior of the tank (400). For example, in some embodiments, the upper and lower trays (422, 424) connect to the tank's (400) long sides in the middle sections of each of the long sides of the tank (400). Connecting the stiffening trays (422, 424) effectively doubles the tank wall thickness in these sections. This then reduces the vibration amplitude of the long sides of the tank (400) to quiet the noise emanating from the tank (400). In other embodiments, these or other stiffening trays may be connected to other sections of the tank (400) as will be apparent to those of ordinary skill in the art in view of the teachings herein.

To connect the stiffening trays (422, 424) to the tank (400), the trays (422, 424) are spot welded to portions of the bottom (406), walls (408), and longitudinal extending supports (434) within the tank (400). For instance, as best seen in FIG. 6, two upper stiffening trays (422) can be positioned side by side along the upper interior middle section of one of the tank's (400) long sides. In this fashion, two of the flanges (430) of the two upper trays (422) are adjacent one another. At the lower end of the upper sheet sections (426) and flanges (430), the upper trays (422) contact the longitudinal extending support (434) on that side of the tank (400). At the upper end of the upper sheet sections (426) and flanges (430), the upper trays (422) contact an upper flange of the wall (408). Spot welds may be made along any or all places where the upper trays (422) contact parts of the tank (400). Furthermore, each of the upper trays (422) comprises bores (436) that can receive a fastener to further secure the upper tray (422) to the wall (408) of the tank (400). In some embodiments, the bores (436) may not receive mechanical fasteners, but may instead provide locations for making spot weld to connect the upper trays (422) with the wall (408) of the tank (400). This or similar connection of the upper trays (422) can be made along both of the long sides of the tank (400). For instance, in the present embodiment, a total of four upper trays (422) are connected to the tank (400), with two upper trays (422) being connected on each side of the tank (400). In other embodiments greater or fewer numbers of upper trays (422) may be used, and the location or placement of the upper trays (422) may be altered from that shown in the above embodiment. Such numbers and placement of the upper trays (422) will be apparent to those of ordinary skill in the art in view of the teachings herein.

To connect the lower stiffening trays (424) to the tank (400), two lower stiffening trays (424) can be positioned side by side along the lower interior middle section of one of the tank's (400) long sides. In this fashion, two of the flanges (432) of the two lower trays (424) are adjacent one another. At the upper end of the flanges (432), the lower trays (424) contact the longitudinal extending support (434) on that side of the tank (400). At the lower end of the lower sheet sections (428) and flanges (432), the lower trays (424) contact the bottom (406) of the tank (400). Spot welds may be made along any or all places where the lower trays (424) contact parts of the tank (400). Furthermore, each of the lower trays (424) comprises bores (438) that can receive a fastener to further secure the lower tray (424) to the wall (408) of the tank (400). In some embodiments, the bores (438) may not receive mechanical fasteners, but may instead provide locations for making spot weld to connect the lower trays (424) with the wall (408) of the tank (400). This or similar connection of the lower trays (424) can be made along both of the long sides of the tank (400). For instance, in the present embodiment, a total of four lower trays (424) are connected to the tank (400), with two lower trays (424) being connected on each side of the tank (400). In other embodiments greater or fewer numbers of lower trays (424) may be used, and the location or placement of the lower trays (424) may be altered from that shown in the above embodiment. Such numbers and placement of the lower trays (424) will be apparent to those of ordinary skill in the art in view of the teachings herein.

Referring to FIG. 9, in one embodiment of the lower tray (424), the flanges (432) extend upward beyond the sheet section (428) of the lower tray (424). In such an embodiment, when connecting the lower tray (424) to the tank (400), the flanges (432) extend upward and contact the longitudinal support (434) while the sheet section (428) remains below the longitudinal support (434). With this configuration, the flanges (430, 432) of the trays (422, 424) extend substantially from the bottom of the tank (400) side to the top of the tank (400) side, or in other words the flanges (430, 432) extend substantially along the entire height of the tank (400) side wall (408). In some other embodiments, the lower tray (424) may be modified such that the flanges (432) extend relative to the sheet section (428) similar to the way the flanges (430) of the upper tray (422) extend relative to the sheet section (426) of the upper tray (422). In other words, the lower tray (424) may be modified to have more contact with the longitudinal support (434) than only at the flanges (432).

Power Unit Configuration

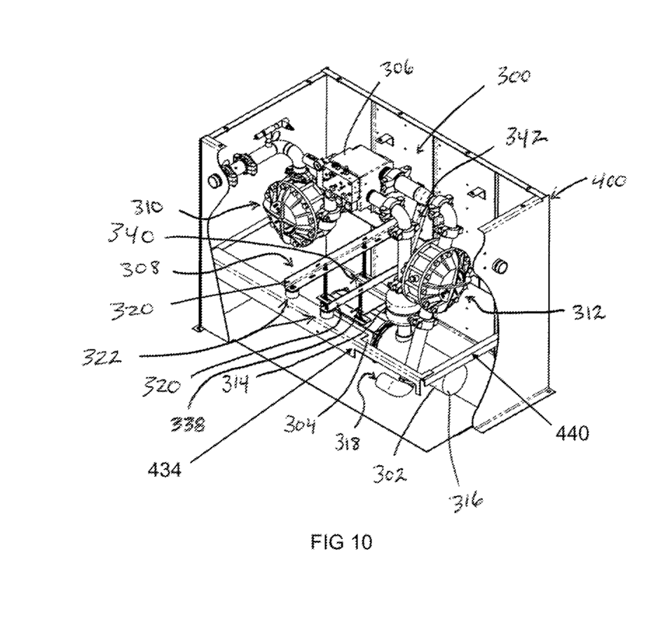

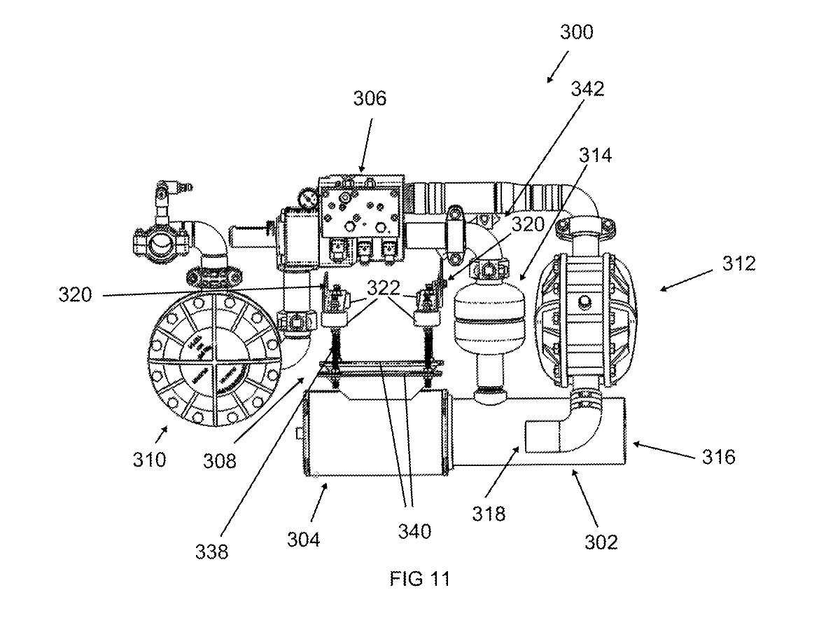

FIG. 10 shows a perspective view of the power unit (300) within the tank (400). The lid (410) and foam sheet (416) are removed in FIG. 10, and a portion of the tank (400) wall (408) is cut-away to reveal the power unit (300) residing within the tank (400). FIG. 11 shows another perspective view of the power unit (300), but removed from the tank (400).

In one embodiment, the power unit (300) comprises a pump (302) coupled to and powered by a motor (304). The pump (302) of the power unit (300) has an inlet (316) where oil (404) from the reservoir (402) is drawn into the pump (302). The power unit (300) further comprises a hanger assembly (308) that connects to the motor (304) and connects the power unit (300) with the tank (400) as will be described in greater detail below. A flow expansion tank (314) is in fluid communication with the pump (302).

In fluid communication with the flow expansion tank (314) is a valve assembly (306). The valve assembly (306) directs the flow of the hydraulic fluid (404) by either permitting hydraulic fluid or oil (404) to flow to the hydraulic cylinder (200) from the tank (400), or by allowing the oil (404) to flow from the hydraulic cylinder (200) to the tank (400). The valve assembly (306) can also recirculate the oil (404) within the tank (400).

A valve-to-cylinder (VTC) silencer assembly (310) is in fluid communication with the valve assembly (306). Also, a valve-to-reservoir (VTR) silencer assembly (312) is in fluid communication with the valve assembly (306). A pipe having an outlet (318) is connected to the VTR silencer assembly (312) such that oil (404) can return to the reservoir (402) by way of the outlet (318). Further connecting these and other components is piping configured to permit oil (404) to flow from one component or location to another. For instance, the VTC silencer assembly (310) is in fluid communication with the hydraulic cylinder (200) by way of such piping.

All or some of the components of power unit (300) may be configured to be fully or partially submersible in the hydraulic fluid (404). For instance the pump (302) and motor (304), among other components, can be of a submersible type. However, in some other embodiments, these and other components may not be of the submersible type.

Referring now to FIG. 10, in one embodiment, the power unit (300) is mounted within the tank (400) by attaching the power unit (300) to the longitudinal supports (434) that extend along the interior long sides of the tank (400). As seen in FIG. 10, in addition to the longitudinal supports (434), the tank (400) also can include lateral supports (440) that extend along the interior short sides of the tank (400). The power unit (300) connects to the longitudinal supports (434) by way of the hanger assembly (308). The hanger assembly (308) comprises a pair of lateral extending crossbars (320). At the ends of the crossbars (320) there is a connection to the longitudinal supports (434). As part of this connection, isolation members (322) are positioned between the crossbars (320) and the longitudinal supports (434). In one embodiment, there are two longitudinal supports (434) that receive two crossbars (320) such that there are four isolation members (322) at each connection point between the crossbars (320) and the longitudinal supports (434). Other configurations and numbers of crossbars (320), longitudinal supports (434), and isolation members (322) may be used in other embodiments and will be apparent to those of ordinary skill in the art in view of the teachings herein.

In the present example, the connection between the crossbars (320), isolation members (322), and the longitudinal supports (434) is achieved using mechanical fasteners. For instance, the crossbars (320), longitudinal supports (434), and isolation members (322) can have bores configured to receive a threaded stud (324). One or more nuts or other fastening members can be used with the stud (324) to establish a tight connection between these components. In other embodiments, other connections means can be used instead of or in addition to mechanical fastening.

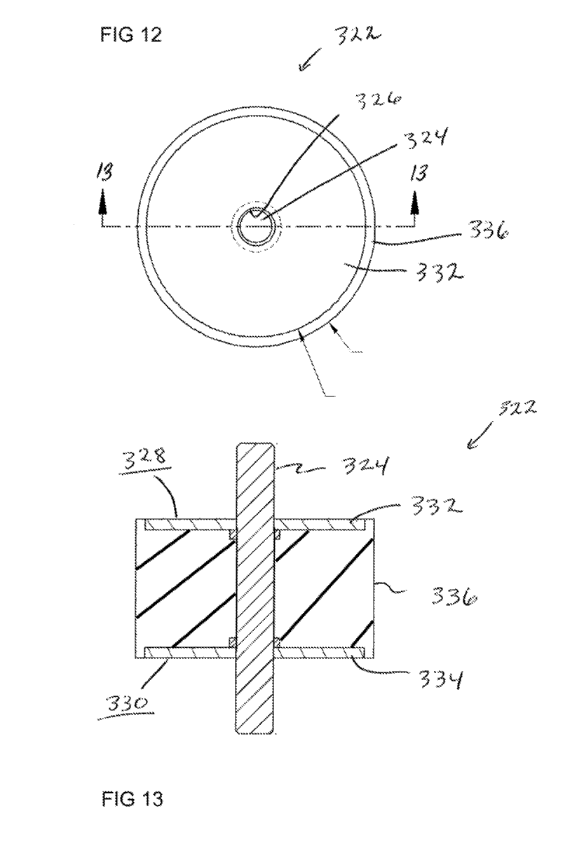

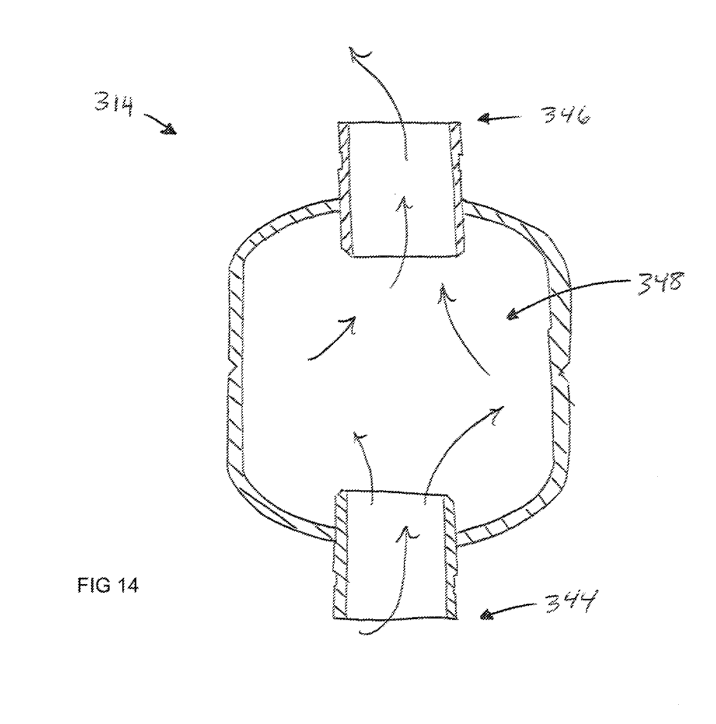

As shown best in FIGS. 11-13, in one embodiment, the isolation members (322) include the stud (324), a top disk (332), a bottom disk (334), and a cylindrical shaped body (336). Each of the top disk (332), bottom disk (334), and the body (336) have bores (326) configured to receive the stud (324). In one embodiment, the isolation members (322) may have a height of about 1.375 inches, and a diameter of about 2.375 inches. The stud (324) may extend about 0.75 inches above and below the respective top and bottom disks (332, 334). These dimensions are exemplary only, and other shapes and sizes may be used for the isolation members (322). The isolation members (322) include a top surface (328) and a bottom surface (330). The top surface (328) is positioned adjacent to an underside of the crossbars (320), while the bottom surface (330) is positioned adjacent to a topside of the longitudinal supports (434). The isolation members (322) are configured to break or dampen the vibration transmission path from the pump (302) and motor (304) to the tank (400). This dampening is achieved by having the body (336) constructed of a dampening or vibration absorbing material. In one embodiment, the body (336) can be neoprene, but other materials may be used such as rubber, nitrile, silicone, and others that will be apparent to those of ordinary skill in the art in view of the teachings herein.

In one embodiment of the isolation members (322), the stud (324) is made of a metal such as steel and is permanently bonded to each top and bottom disk (332, 334), which are also made of a metal such as steel. The neoprene body (336) is attached between and to each of the top disk (332) and the bottom disk (334). By way of example only, and not limitation, in one embodiment, with a load of 300 pounds, the maximum compression deflection of the isolation member (322) is 0.150 or less. Also by way of example only, and not limitation, in one embodiment, with a load of 90 pounds, the maximum sheer deflection is 0.150 or less. While the isolation members (322) are illustrated with top and bottom disks (332, 334), in some other embodiments, one or both of top and bottom disks (332, 334) may be omitted. In view of the teachings herein, other ways to construct, configure, and connect isolation member (322) will be apparent to those of ordinary skill in the art.

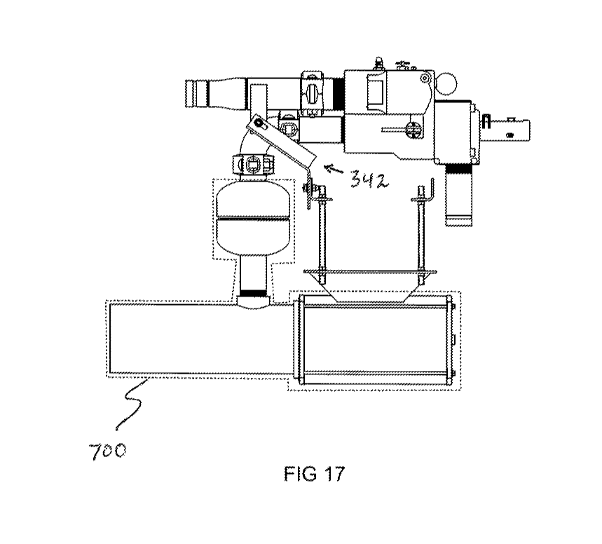

In addition to connecting with the longitudinal supports (434), the hanger assembly (308) connects with the motor (304), thereby mounting the power unit (300) to and within the tank (400). As shown in FIGS. 10 and 17, rods (338) connect the crossbars (320) with brackets (340). This connection can be achieved using mechanical fasteners or other means as will be apparent to those of ordinary skill in the art in view of the teachings herein. The brackets (340) are attached with the motor (304), for instance by welding or other attachment means. With this configuration, the components of the power unit (300) are mounted within the tank (400) in a suspended fashion such that the pump (302) and the motor (304) are not directly contacting the bottom (406) of the tank (400).

In an embodiment of the hanger assembly (308), a further stabilizing assembly (342) can be provided as part of the hanger assembly (308), but may not be required in all embodiments. As seen in FIGS. 10, 11, and 17, the stabilizing assembly (342) comprises three brackets connected or otherwise fastened together that establish a connection between a crossbar (320) of the hanger assembly (308) and one of the return pipe pieces extending from the valve assembly (306) to the VTR silencer (312). The brackets of the stabilizing assembly (342) may be modified in their shape or size to accommodate various sized power units (300) where the distances or spans between components may change based on the specifications of the particular power unit.

Referring again to FIGS. 10, 11, and 17, in fluid communication with the pump (302) is the expansion tank (314). The expansion tank (314) is configured to modify the flow characteristics of the oil (404) as the oil (404) flows from the reservoir (402) of the tank (400) to the hydraulic cylinder (200). The expansion tank (314) comprises an inlet (344), an outlet (346), and an internal chamber or volume (348) that connects to the inlet (344) at one end and the outlet (346) at the other end. Connected to the inlet (344) is a pipe that connects the expansion tank (314) with the pump (302). Connected to the outlet (346) is a pipe that connects the expansion tank (314) with the valve assembly (306). The internal chamber (348), in one embodiment, comprises a cylindrically shaped void space having a greater diameter than the pipes connected to the inlet (344) and outlet (346).

The larger diameter through the expansion tank (314) increases the cross-sectional flow area and hence fluid flow properties of the oil (404) through this area such that the amount of turbulence is reduced compared to the flow properties within the pipes adjacent to the expansion tank (314), which have a smaller cross-sectional flow area. The reduction in turbulence of the flow allows for reduced noise and vibration that can be associated with turbulent flows of fluid. Additionally, the change in the cross-section flow area alters the uniform flow pulses created by the pump (302). This alteration can reduce fluidborne noise by reducing the pulsation amplitude produced by the pump (302). Furthermore, with the placement of the expansion tank (314) near the pump (302) and before the valve assembly (306) and control valve, the reduction in the pulsation amplitude produced by the pump (302), and hence the fluidborne noise, occurs early in the power unit (300). This is before the fluidborne noise from the pump (302) pulses have a chance to act on the other components of the power unit (300). Thus the chance of high fluidborne noise from the pump (302) pulses potentially generating vibration and airborne noise in downstream components of the power unit (300) is avoided or reduced.

In other embodiments, the expansion tank (314) may have different configurations for the location of the inlet (344) and outlet (346) as well as the shape and size of the internal chamber (348). In view of the teachings herein, those of ordinary skill in the art will understand other ways in which the expansion tank (314) can be modified to alter the fluid flow properties to reduce noise and vibrations as oil (404) flows from the tank (400) to the hydraulic cylinder (200).

When operating the pump (302) to direct the flow of the oil (404), after the oil (404) has flowed through the pump (302) and through the expansion tank (314), the oil (404) flows through the valve assembly (306). In the present embodiment, the valve assembly (306) is controlled to direct the flow of the oil (404) in one of two ways. In one way, the oil (404) may be directed to the hydraulic cylinder (200) to raise the elevator car (100). In another way, the oil (404) may be recirculated within the tank (400), without necessarily directing the oil (404) to the hydraulic cylinder (200).

The valve assembly (306) is further configured to direct the flow of the oil (404) during the elevator car (100) lowering. In this process, the oil (404) flows from the hydraulic cylinder (200) back through the valve assembly (306) and to the reservoir (402) within the tank (400). In the present embodiment, the portion of the power unit (300) used for recirculating the oil (404) is also used when the oil (404) flows from the hydraulic cylinder (200) back to the tank (400). These flows of the oil (404), and certain components of the power unit (300) that are used in directing the flows, will be described in more detail below

Beginning with the oil (404) flow from the tank (400) to the hydraulic cylinder (200), from the valve assembly (306), the oil (404) flows to the VTC silencer assembly (310) before ultimately flowing through piping to the hydraulic cylinder (200). Thus in one embodiment, the VTC silencer assembly (310) is positioned between the valve assembly (306) and the hydraulic cylinder (200). The VTC silencer assembly (310) is configured to modify the flow properties of the oil (404) to reduce noise and vibration associated with fluid flow. In some embodiments, the VTC silencer assembly (310) may also be configured to filter the oil (404) to remove any potentially harmful particulate matter. However, such filtering is not required in all embodiments.

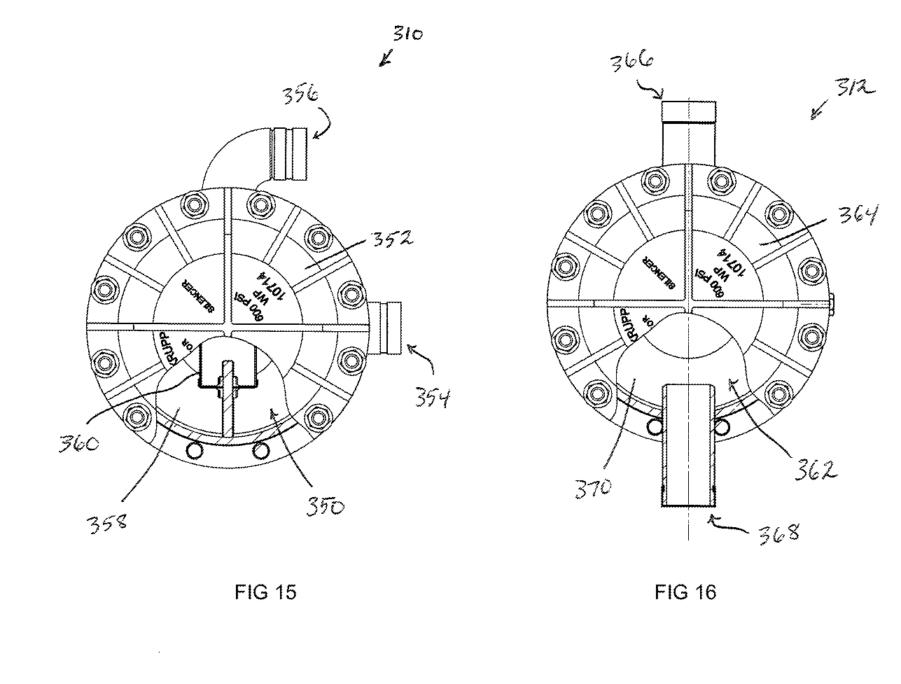

Referring to FIG. 15, in one embodiment, the VTC silencer assembly (310) comprises a chamber (350) and two caps (352) that connect together around the chamber (350) to effectively seal the chamber (350) with the exception of an inlet (354) and an outlet (356). In one embodiment, the caps (352) are constructed from a heavy, thick-walled, cast iron and connect using mechanical fasteners such as bolts and nuts as shown in FIGS. 11 and 15. The heavy cast iron construction of the caps (352) reduces some of the airborne noise that would typically be emitted from a pipe or other thin-walled structure. In some embodiments there are one or more cores (358) disposed within the VTC silencer assembly (310). The cores (358) provide energy absorption and dampening and in some embodiments are compressible to some degree. In one such embodiment, the cores (358) comprise neoprene cores or disks, however, in other embodiments, other materials may be used for the cores (358) such as nitrile, rubber, elastomers, and others that will be apparent to those of ordinary skill in the art in view of the teachings herein. The cores (358) are positioned within the VTC silencer assembly (310) near the two caps (352), with one core (358) associated with each cap (358) such that the chamber (350) and space for oil (404) flow can be defined by the space between the cores (358).

In additional embodiments, a strainer (360) may be disposed within the chamber (350) of the VTC silencer assembly (310). The strainer (360) is configured to filter the oil (404) to change a uniform flow profile of the oil (404) into many tiny streams that need to come back to a much altered flow profile to leave the VTC silencer assembly (310). In some embodiments, the strainer (360) may be further configured to trap solids and particulate matter that might otherwise damage components or degrade operability. For example, when the oil (404) enters the VTC silencer assembly (310) during an up run of the elevator car (100) where oil (404) is being sent to the hydraulic cylinder (200), the oil (404) flows from the inlet (356), through the strainer (360), and into the chamber (350) to the outlet (354). In this configuration, the inlet (356) is connected to the strainer (360) such that for the oil (404) to flow to the outlet (356) and into the hydraulic cylinder (200), the oil (404) flows through the inlet (356) and enters into an interior cavity or volume within the strainer (360), where it then passes from the interior cavity through the perforated wall of the strainer (360) to the chamber (350) outside of the strainer. After passing through the strainer into the chamber (350), the oil exits the VTC silencer assembly (310) through the outlet (354). When the elevator car (100) is permitted to be lowered and travel downward in the hoistway, for example by the force of gravity acting on the car, which forces the oil (404) to exit the hydraulic cylinder (200), the oil (404) flows in the reverse manner through VTC silencer assembly (310).

In the present embodiment shown in FIG. 15, the VTC silencer assembly (310) has a cylindrical shape with the outlet (354) located on the side of the VTC silencer assembly (310) at generally the 3 o'clock position, and the inlet (356) is located on the top of the VTC silencer assembly (310) at generally the 6 o'clock position. In this configuration, the inlet (356) and the outlet (354) are oriented or positioned such that they enter the VTC silencer assembly (310) substantially perpendicular to each other. In other embodiments, the shape, size, position, orientation, and configuration of each of the inlet and outlet may differ without departing from the scope of the present disclosure. In terms of size and volume, similar to the expansion tank (314), the chamber (350) of the VTC silencer assembly (310) has a greater diameter than the pipes that connect to the VTC silencer assembly (310). The larger diameter through the VTC silencer assembly (310) increases the cross-sectional flow area and hence changes the fluid flow properties of the oil (404) through this area such that the amount of turbulence is reduced compared to the flow properties within the pipes adjacent to the VTC silencer assembly (310), which have a smaller cross-sectional flow area. The reduction in turbulence of the flow allows for reduced noise and vibration that can be associated with more turbulent flows of fluid. Additionally, the change in the cross-sectional flow area alters the uniform flow pulses created by the pump (302). This alteration can reduce fluidborne noise by reducing the pulsation amplitude produced by the pump (302). Furthermore, the larger volume of the VTC silencer assembly (310) provides space for pulse reflection, which reduces the amplitude of the noise.

Referring to FIGS. 10, 11, and 16, a second silencer assembly, the VTR silencer assembly (312), is included with power unit (300). The VTR silencer assembly (312) is positioned between the valve assembly (306) and the reservoir (402) of the tank (400). This can be referred to as the return line or return path, as the oil (404) travels this path when returning to the reservoir (402). The oil (404) will take this return line through the VTR silencer assembly (312) during downward travel of the elevator car (100) within the hoistway as the oil (404) is being directed from the hydraulic cylinder (200) back to the tank (400). In some embodiments, the oil (404) can also take this return path through the VTR silencer assembly (312) during upward travel of the elevator car (100) when the oil (404) flow bypasses through the valve assembly (306) back to the tank (400), e.g. when the elevator car (100) is being held in a raised position with the pump (302) still running.

Similar to the VTC silencer assembly (310), the VTR silencer assembly (312) is configured to modify the flow properties of the oil (404). In one embodiment, the VTR silencer assembly (312) comprises a chamber (362) and two caps (364) that connect together around the chamber (362) to effectively seal the chamber (362) with the exception of an inlet (366) and an outlet (368). In one embodiment, the caps (364) are constructed from a heavy, thick-walled, cast iron and connect using mechanical fasteners such as bolts and nuts as shown in FIGS. 11 and 16. The heavy cast iron construction of the caps (364) reduces some of the airborne noise that would typically be emitted from a pipe or other thin-walled structure. In some embodiments there are one or more cores (370) disposed within the VTR silencer assembly (312). The cores (370) provide energy absorption and dampening and in some embodiments are compressible to some degree. In one such embodiment, the cores (370) comprise neoprene cores or disks, however in other embodiments other materials may be used for the cores (370) such as nitrile, rubber, elastomers, and others that will be apparent to those of ordinary skill in the art in view of the teachings herein. The cores (370) are positioned within the VTR silencer assembly (312) near the two caps (364), with one core (370) associated with each cap (364) such that the chamber (362) and space for oil (404) flow can be defined by the space between the cores (370). Although not shown in the illustrated embodiment of the VTR silencer assembly (312), in some embodiments, a strainer may be disposed within the chamber (362) of the VTR silencer assembly (312) that is similar to the strainer (360) disposed within the VTC silencer assembly (310).

In the present embodiment shown in FIG. 16, the VTR silencer assembly (312) has a cylindrical shape with the outlet (368) located on the bottom of the VTR silencer assembly (312) at generally the 6 o'clock position, and the inlet (366) is located on the top of the VTR silencer assembly (312) at generally the 12 o'clock position. In this configuration, the inlet (366) and the outlet (368) are oriented or positioned about 180 degrees relative to one another, such that they enter the VTR silencer assembly (312) substantially in-line with one another on opposite sides of the VTR silencer assembly (312). In other embodiments, the shape, size, position, orientation, and configuration of each of the inlet and outlet may differ without departing from the scope of the present disclosure. In terms of size and volume, similar to the expansion tank (314), the chamber (362) of the VTR silencer assembly (312) has a greater diameter than the pipes that connect to the VTR silencer assembly (312). The larger diameter through the VTR silencer assembly (312) increases the cross-sectional flow area and hence changes the fluid flow properties of the oil (404) through this area such that the amount of turbulence is reduced compared to the flow properties within the pipes adjacent to the VTR silencer assembly (312), which have a smaller cross-sectional flow area. The reduction in turbulence of the flow allows for reduced noise and vibration that can be associated with more turbulent flows of fluid. In operation, when the oil (404) leaves the valve assembly (306) and enters the return line to return back to the reservoir (402), the oil (404) is going from high pressure to atmospheric pressure. The flow of fluid can be turbulent and loud, and also prone to inducing vibrations in the system. The VTR silencer assembly (312) modifies the flow properties of the oil (404) as mentioned above due to its larger diameter cross-sectional flow. Furthermore, the larger volume of the VTR silencer assembly (312) and the compressible cores (370) provide space and areas for flow deflection, which can alter the fluid flow properties and reduce the amplitude of the noise associated with the fluid flow as discussed above.

As shown in FIGS. 17-25, but not required in all embodiments, components of power unit (300) may also be wrapped in a noise blanket or jacket (700) to thereby inhibit transmission of noise and/or vibrations from the power unit (300). The blanket (700) of the present embodiment comprises a layer of insulation (702) wrapped in a film (704). The insulation (702) comprises closed cell foam, but in alternate embodiments may comprise other suitable materials without departing from the scope of the present disclosure. In some embodiments the insulation (702) can comprise an oil-resistant neoprene, vinyl, or Buna-N foam having a temperature use range of −40 to 200 degrees F., a firmness of 5-9 psi, and a density of 5.5-7.5 lbs/cu ft. An exemplary insulation (702) includes Armacell Ensolite IG2, available from Armacell LLC. In some embodiments, the film (704) comprises Mylar or PAKDRY 7500, which is sold by IMPAK Corporation; other suitable film materials that have high moisture and gas barrier properties may also be used. In one embodiment the film (704) has a thickness of about 7.5 mils with a dual layer of both 48 gauge polyester and 60 gauge biaxially oriented nylon to provide strength and durability. Furthermore, in this embodiment, a 6.0 mil metallocene PE sealant layer is used. In some embodiments, the film (704) may comprise a foil layer as well. Other materials for the insulation (702) and the film (704) will be apparent to one of ordinary skill in the art in view of the teachings herein.

The film (704) is configured to prevent the oil (404) from coming into contact with the insulation (702) to thereby maintain an air barrier or air gap (706) between the wrapped power unit (300) components and the exterior surface (708) of the blanket (700). Accordingly, the blanket or jackets (700) provide an air barrier (706) between the noise generating components of the power unit (300) and the side of the tank (400). The change in the speed of the sound as it travels from the pumped oil through the air barrier (706) and then through the oil (404) in the reservoir (402) reduces the noise as measured outside of the tank (400). As shown in FIG. 17, the pump (302), motor (304), expansion tank (314), and piping connecting these components are wrapped in the blanket (700). It should be appreciated that in other embodiments, more or fewer components of power unit (300) may be wrapped in the blanket (700).

To maintain the air barrier (706), the blanket or jacket pieces (700) are heat sealed together under vacuum conditions. In one embodiment, the heat seal strength is greater than 11 lbs/in width. In one embodiment, the heat seal conditions provide for maintaining the seal at 425 degrees F. at 40 psi for 1 second. A partial vacuum can be pulled on the film (704) prior to its final seal.

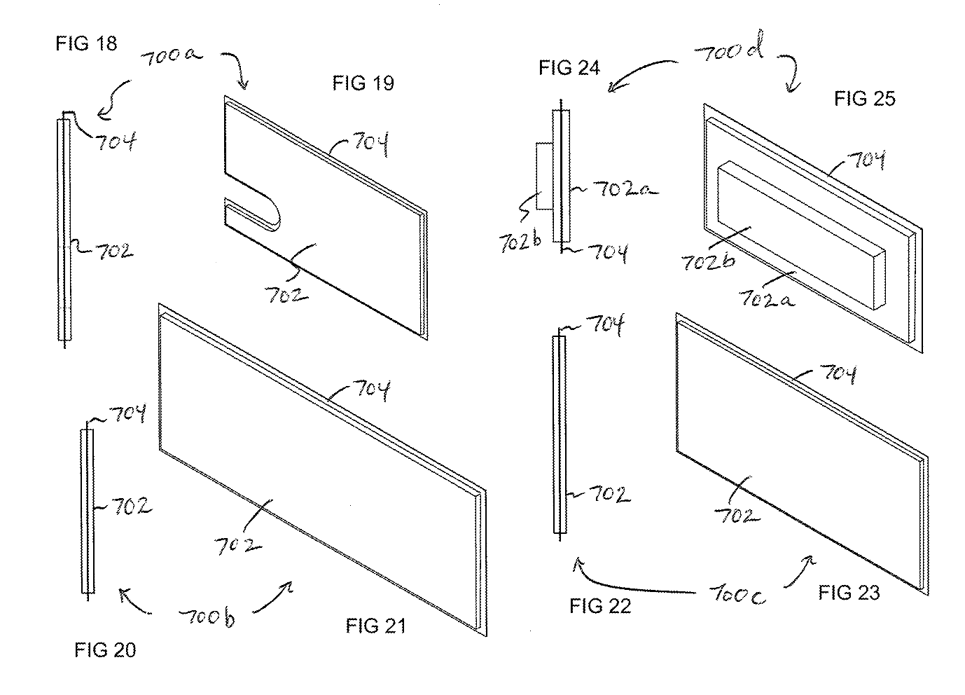

Referring now to FIGS. 18-25, several side and perspective views show portions of the noise blanket (700). These portions are placed and then heat sealed together to form the noise blanket (700) depicted in FIG. 17. For instance, FIGS. 18-23 show portions (700a, 700b, 700c, 700d) of the noise blanket (700) where each portion comprises a piece of foam insulation (702) and a section of film (704). As shown in FIGS. 18-23, the film (704) is positioned in the middle of the insulation (702). In one embodiment, the insulation (702) may comprise two sheets of foam where each is attached to one side of the film (704) to create the portion of the noise blanket (700). In one such embodiment, the foam insulation (702) has a thickness of about 0.75 inches and the film (704) extends beyond the foam insulation (702) by 0.375 to 0.5 inches on all sides.

Referring to FIGS. 24 and 25, the portion (700d) of the noise blanket (700) configured to wrap the top of the motor (304) comprises a first foam insulation (702a) and a second foam insulation (702b). In some embodiments this additional layer of foam insulation can be targeted to wrap areas of high noise generation. The film (704) of the portion (700d) to wrap the top of the motor (304) is positioned in the middle of the first insulation (702a). The second insulation (702b) is attached to the first insulation (702a). As with the other portions (700a, 700b, 700c), the portion (700d) of the noise blanket (700) for the top of the motor (304), at least in one embodiment, can have the first and second foam insulations (702a, 702b) each having a thickness of about 0.75 inches. The film (704) extends beyond the first foam insulation (702a) by 0.375 to 0.5 inches on all sides.

To assemble the noise blank (700), as mentioned above, the insulation (702) is heat sealed within the film or cover (704). As such, the portions (700a, 700b, 700c, 700d) of the noise blanket (700) are wrapped around their respective components of the power unit (300), and then the edges or parts of the film (704) that extend beyond the insulation (702) are heat sealed together as described above. Before the final seal is made, a vacuum is pulled to ensure the noise blanket (700) is airtight. In view of the teachings herein, other ways to wrap noise generating components of the power unit (300) will be apparent to one of ordinary skill in the art without departing from the scope of the present disclosure.

It should be understood that any one or more of the teachings, expressions, embodiments, examples, etc. disclosed herein may be combined with any one or more of the other teachings, expressions, embodiments, examples, etc. that are disclosed herein. The teachings, expressions, embodiments, examples, etc. disclosed herein should therefore not be viewed in isolation relative to each other. Various suitable ways in which numerous aspects of the present disclosure may be combined will be readily apparent to those of ordinary skill in the art in view of the teachings disclosed herein. Such modifications and variations are intended to be included within the scope of both the present disclosure and the claims.

Having shown and described various embodiments of the present disclosure, further adaptations of the methods and systems described herein may be accomplished by appropriate modifications by one of ordinary skill in the art without departing from the scope of the present disclosure. Several of such potential modifications have been mentioned, and others will be apparent to those skilled in the art. For instance, examples, embodiments, geometrics, materials, dimensions, ratios, steps, and the like discussed above are illustrative and are not required. Accordingly, the scope of the present disclosure should be considered in terms of the following claims and is understood not to be limited to the details of structure and operation shown and described in the specification and drawings.

I/We claim:

1. A hydraulic elevator system comprising:
a tank configured to be mounted to a floor;
a pump disposed within the tank and operable to transfer hydraulic fluid through a power unit;
a motor connected to the pump and operable to drive the pump; and
an expansion tank in fluid communication with the pump, wherein the expansion tank comprises an increased cross-sectional flow area compared to adjacent piping connected to the expansion tank.

2. The system of claim 1, wherein the tank comprises an insulated and sealed lid.

3. The system of claim 2, wherein the insulated and sealed lid comprises a closed-cell foam insulation.

4. The system of claim 1, wherein the lid is constructed of sheet metal having a 12 gage thickness.

5. The system of claim 1, further comprising a dampening pad positioned between a bottom of the tank and the floor.

6. The system of claim 5, wherein the dampening pad are constructed of a nitrile material.

7. The system of claim 5, wherein multiple dampening pads are positioned between the bottom of the tank and the floor.

8. The system of claim 1, wherein the tank comprises a stiffening member configured to stiffen the tank along its greatest length.

9. The system of claim 8, comprising multiple stiffening members configured to be spot welded together and to the tank.

10. The system of claim 8, comprising upper and lower stiffening members, wherein the upper stiffening members are positioned above a longitudinal support of the tank, and wherein the lower stiffening members are positioned below the longitudinal support of the tank.

11. The system of claim 1, further comprising a silencer assembly positioned between a valve assembly and a reservoir of the tank.

12. A power unit for driving a hydraulic elevator system, comprising:
a pump mountable within a tank of the hydraulic elevator system and configured to drive hydraulic fluid through the power unit;
a motor coupled to the pump and configured to drive the pump;
a valve assembly in fluid communication with the pump and configured to selectively direct the flow of the driven hydraulic fluid; and
a first silencer assembly in fluid communication with both of the valve assembly and a hydraulic fluid reservoir of the tank, the first silencer assembly being disposed along a hydraulic fluid return line that directs the hydraulic fluid from the valve assembly to the reservoir of the tank.

13. The power unit of claim 12, wherein the first silencer assembly comprises a chamber and a core, wherein the core is configured to dampen fluidborne noise and vibration.

14. The power unit of claim 13, wherein the core comprises a neoprene disk.

15. The power unit of claim 12, further comprising a second silencer assembly in fluid communication with the valve assembly and the hydraulic cylinder.

16. The power unit of claim 15, wherein the second silencer assembly comprises a strainer.

17. The power unit of claim 12, comprising a hanger assembly configured to mount the power unit to the tank, wherein the hanger assembly comprises an isolator configured to dampen vibration between the power unit and the tank.

18. The power unit of claim 12, further comprising an expansion tank in fluid communication with the pump, wherein the expansion tank comprises an increased cross-sectional flow area compared to adjacent piping connected to the expansion tank.

19. The power unit of claim 12, further comprising a noise blanket configured to wrap the motor and the pump of the power unit, wherein the noise blanket comprises two or more closed-cell foam pieces and two or more film pieces, wherein the foam pieces are sealed within the noise blanket by sealing portions of the two or more film pieces together to create an air barrier within the noise blanket.
